(19) United States
(12) Patent Application Publication
(10) Pub. No.: US 2017/0014937 A1
(43) Pub. Date: Jan. 19, 2017

(54) ALUMINUM ALLOY PRODUCTS, AND METHODS OF MAKING THE SAME

(71) Applicant: ALCOA INC., Pittsburgh, PA (US)

(72) Inventors: Deborah M. Wilhelmy, Greensburg, PA (US); Lynnette M. Karabin, Ruffs Dale, PA (US); Cagatay Yanar, Pittsburgh, PA (US); John Siemon, Cheswick, PA (US); Raymond J. Kilmer, Pittsburgh, PA (US); David W. Heard, Pittsburgh, PA (US); Gen Satoh, Murrysville, PA (US)

(21) Appl. No.: 15/279,026

(22) Filed: Sep. 28, 2016

Related U.S. Application Data
(63) Continuation of application No. PCT/US2016/022168, filed on Mar. 11, 2016.
(60) Provisional application No. 62/132,345, filed on Mar. 12, 2015.

(51) Int. Cl. B23K 10/02; B23K 35/02; B23K 35/28; B33Y 40/00; B23K 35/368; B33Y 10/00; B33Y 70/00; B23K 15/00; B23K 35/36

(52) U.S. Cl. CPC B23K 10/027; B23K 15/0086; B23K 15/0093; B23K 35/0261; B23K 35/0255; B23K 35/286; B23K 35/361; B23K 35/3601; B23K 35/368; B33Y 10/00; B33Y 70/00; B33Y 40/00; B23K 2203/10

(57) ABSTRACT

The present disclosure relates to new metal powders for use in additive manufacturing, and aluminum alloy products made from such metal powders via additive manufacturing. The composition(s) and/or physical properties of the metal powders may be tailored. In turn, additive manufacturing may be used to produce a tailored aluminum alloy product.

### CROSS-REFERENCE TO RELATED APPLICATIONS

This patent application is a continuation of International Patent Application No. PCT/US2016/022168 filed Mar. 11, 2016, entitled “ALUMINUM ALLOY PRODUCTS, AND METHODS OF MAKING THE SAME”, which claims the benefit of priority of U.S. Provisional Patent Application No. 62/132,345, filed Mar. 12, 2015, each of which is incorporated herein by reference in its entirety.

### BACKGROUND

Aluminum alloy products are generally produced via either shape casting or wrought processes. Shape casting generally involves casting a molten aluminum alloy into its final form, such as via pressure-die, permanent mold, green- and dry-sand, investment, and plaster casting. Wrought products are generally produced by casting a molten aluminum alloy into ingot or billet. The ingot or billet is generally further hot worked, sometimes with cold work, to produce its final form.

### SUMMARY OF THE INVENTION

Broadly, the present disclosure relates to metal powders for use in additive manufacturing, and aluminum alloy products made from such metal powders via additive manufacturing. The composition(s) and/or physical properties of the metal powders may be tailored. In turn, additive manufacturing may be used to produce a tailored aluminum alloy product.

### BRIEF DESCRIPTION OF THE DRAWINGS

FIG. 1 is a schematic, cross-sectional view of an additively manufactured product (100) having a generally homogenous microstructure.

FIGS. 2a-2d are schematic, cross-sectional views of an additively manufactured product produced from a single metal powder and having a first region (200) of aluminum or an aluminum alloy and a second region (300) of an multiple metal phase, with FIGS. 2b-2d being deformed relative to the original additively manufactured product illustrated in FIG. 2a.

FIGS. 3a-3f are schematic, cross-sectional views of additively manufactured products having a first region (400) and a second region (500) different than the first region, where the first region is produced via a first metal powder and the second region is produced via a second metal powder, different than the first metal powder.

FIG. 4 is a flow chart illustrating some potential processing operations that may be completed relative to an additively manufactured aluminum alloy product. Although the dissolving (20), working (30), and precipitating (40) steps are illustrated as being in series, the steps may be completed in any applicable order.

FIG. 5a is a schematic view of one embodiment of using electron beam additive manufacturing to produce an aluminum alloy body.

FIG. 5b illustrates one embodiment of a wire useful with the electron beam embodiment of FIG. 5a, the wire having an outer tube portion and a volume of particles contained within the outer tube portion.

### DETAILED DESCRIPTION

As noted above, the present disclosure relates to metal powders for use in additive manufacturing, and aluminum alloy products made from such metal powders via additive manufacturing. The composition(s) and/or physical properties of the metal powders may be tailored. In turn, additive manufacturing may be used to produce a tailored aluminum alloy product.

The new aluminum alloy products are generally produced via a method that facilitates selective heating of powders to temperatures above the liquidus temperature of the particular aluminum alloy product to be formed, thereby forming a molten pool followed by rapid solidification of the molten pool. The rapid solidification facilitates maintaining various alloying elements in solid solution with aluminum. In one embodiment, the new aluminum alloy products are produced via additive manufacturing techniques. Additive manufacturing techniques facilitate the selective heating of powders above the liquidus temperature of the particular aluminum alloy, thereby forming a molten pool followed by rapid solidification of the molten pool

As used herein, “additive manufacturing” means “a process of joining materials to make objects from 3D model data, usually layer upon layer, as opposed to subtractive manufacturing methodologies”, as defined in ASTM F2792-12a entitled “Standard Terminology for Additively Manufacturing Technologies”. The aluminum alloy products described herein may be manufactured via any appropriate additive manufacturing technique described in this ASTM standard, such as binder jetting, directed energy deposition, material extrusion, material jetting, powder bed fusion, or sheet lamination, among others. In one embodiment, an additive manufacturing process includes depositing successive layers of one or more powders and then selectively melting and/or sintering the powders to create, layer-by-layer, an aluminum alloy product. In one embodiment, an additive manufacturing processes uses one or more of Selective Laser Sintering (SLS), Selective Laser Melting (SLM), and Electron Beam Melting (EBM), among others. In one embodiment, an additive manufacturing process uses an EOSINT M 280 Direct Metal Laser Sintering (DMLS) additive manufacturing system, or comparable system, available from EOS GmbH (Robert-Stirling-Ring 1, 82152 Krailling/Munich, Germany).

In one embodiment, a method comprises (a) dispersing a powder in a bed, (b) selectively heating a portion of the powder (e.g., via a laser) to a temperature above the liquidus temperature of the particular aluminum alloy product to be formed, (c) forming a molten pool and (d) cooling the molten pool at a cooling rate of at least 1000° C. per second. In one embodiment, the cooling rate is at least 10,000° C. per second. In another embodiment, the cooling rate is at least 100,000° C. per second. In another embodiment, the cooling rate is at least 1,000,000° C. per second. Steps (a)-(d) may be repeated as necessary until the aluminum alloy product is completed.

As used herein, “metal powder” means a material comprising a plurality of metal particles, optionally with some non-metal particles. The metal particles of the metal powder may be all the same type of metal particles, or may be a blend of metal particles, optionally with non-metal particles, as described below. The metal particles of the metal powder may have pre-selected physical properties and/or pre-selected composition(s), thereby facilitating production of tailored aluminum alloy products. The metal powders may be used in a metal powder bed to produce a tailored aluminum alloy product via additive manufacturing. Similarly, any non-metal particles of the metal powder may have pre-selected physical properties and/or pre-selected composition(s), thereby facilitating production of tailored aluminum alloy products. The non-metal powders may be used in a metal powder bed to produce a tailored aluminum alloy product via additive manufacturing

As used herein, “metal particle” means a particle comprising at least one metal. The metal particles may be one-metal particles, multiple metal particles, and metal-non-metal (M-NM) particles, as described below. The metal particles may be produced, for example, via gas atomization.

As used herein, a “particle” means a minute fragment of matter having a size suitable for use in the powder of the powder bed (e.g., a size of from 5 microns to 100 microns). Particles may be produced, for example, via gas atomization.

For purposes of the present patent application, a “metal” is one of the following elements: aluminum (Al), silicon (Si), lithium (Li), any useful element of the alkaline earth metals, any useful element of the transition metals, any useful element of the post-transition metals, and any useful element of the rare earth elements.

As used herein, useful elements of the alkaline earth metals are beryllium (Be), magnesium (Mg), calcium (Ca), and strontium (Sr).

As used herein, useful elements of the transition metals are any of the metals shown in Table 1, below.

TABLE 1
Transition Metals

| Group | 4 | 5 | 6 | 7 | 8 | 9 | 10 | 11 | 12 |
|---|---|---|---|---|---|---|---|---|---|
| Period 4 | Ti | V | Cr | Mn | Fe | Co | Ni | Cu | Zn |
| Period 5 | Zr | Nb | Mo | | Ru | Rh | Pd | Ag | |
| Period 6 | Hf | Ta | W | Re | | | Pt | Au | |

As used herein, useful elements of the post-transition metals are any of the metals shown in Table 2, below.

TABLE 2
Post-Transition Metals

| Group | 13 | 14 | 15 |
|---|---|---|---|
| Period 4 | Ga | Ge | |
| Period 5 | In | Sn | |
| Period 6 | | Pb | Bi |

As used herein, useful elements of the rare earth elements are scandium, yttrium and any of the fifteen lanthanides elements. The lanthanides are the fifteen metallic chemical elements with atomic numbers 57 through 71, from lanthanum through lutetium.

As used herein non-metal particles are particles essentially free of metals. As used herein “essentially free of metals” means that the particles do not include any metals, except as an impurity. Non-metal particles include, for example, boron nitride (BN) and boron carbine (BC) particles, carbon-based polymer particles (e.g., short or long chained hydrocarbons (branched or unbranched)), carbon nanotube particles, and graphene particles, among others. The non-metal materials may also be in non-particulate form to assist in production or finalization of the aluminum alloy product.

In one embodiment, at least some of the metal particles of the metal powder consists essentially of a single metal (“one-metal particles”). The one-metal particles may consist essentially of any one metal useful in producing an aluminum alloy, such as any of the metals defined above. In one embodiment, a one-metal particle consists essentially of aluminum. In one embodiment, a one-metal particle consists essentially of copper. In one embodiment, a one-metal particle consists essentially of manganese. In one embodiment, a one-metal particle consists essentially of silicon. In one embodiment, a one-metal particle consists essentially of magnesium. In one embodiment, a one-metal particle consists essentially of zinc. In one embodiment, a one-metal particle consists essentially of iron. In one embodiment, a one-metal particle consists essentially of titanium. In one embodiment, a one-metal particle consists essentially of zirconium. In one embodiment, a one-metal particle consists essentially of chromium. In one embodiment, a one-metal particle consists essentially of nickel. In one embodiment, a one-metal particle consists essentially of tin. In one embodiment, a one-metal particle consists essentially of silver. In one embodiment, a one-metal particle consists essentially of vanadium. In one embodiment, a one-metal particle consists essentially of a rare earth element.

In another embodiment, at least some of the metal particles of the metal powder include multiple metals (“multiple-metal particles”). For instance, a multiple-metal particle may comprise two or more of any of the metals listed in the definition of metals, above. In one embodiment, a multiple-metal particle consists of an aluminum alloy, such as any of the 1xxx, 2xxx, 3xxx, 4xxx, 5xxx, 6xxx, 7xxx, and 8xxx aluminum alloys, as defined by the Aluminum Association document “International Alloy Designations and Chemical Composition Limits for Wrought Aluminum and Wrought Aluminum Alloys” (2009) (a.k.a., the “Teal Sheets”), incorporated herein by reference in its entirety. In another embodiment, a multiple-metal particle consists of a casting aluminum alloy or ingot alloy, such as any of the 1xx, 2xx, 3xx, 4xx, 5xx, 7xx, 8xx and 9xx aluminum casting and ingot alloys, as defined by the Aluminum Association document “Designations and Chemical Composition Limits for Aluminum Alloys in the Form of Castings and Ingot” (2009) (a.k.a., “the Pink Sheets”), incorporated herein by reference in its entirety.

In one embodiment, a metal particle consists of a composition falling within the scope of a 1xxx aluminum alloy. As used herein, a “1xxx aluminum alloy” is an aluminum alloy comprising at least 99.00 wt. % Al, as defined by the Teal Sheets, optionally comprising tolerable levels of oxygen (e.g., from about 0.01 to 0.20 wt. % O) therein due to normal additive manufacturing processes. The “1xxx aluminum alloy” compositions include the 1xx alloy compositions of the Pink Sheets. A 1xxx aluminum alloy includes pure aluminum products (e.g., 99.99% Al products). A metal particle of a 1xxx aluminum alloy may be a one-metal particle (for pure aluminum products), or a metal particle of a 1xxx aluminum alloy may be a multiple-metal particle (for non-pure 1xxx aluminum alloy products). As used herein, the term “1xxx aluminum alloy” only refers to the composition and not any associated processing, i.e., as used herein a 1xxx aluminum alloy product does not need to be a wrought product to be considered a 1xxx aluminum alloy composition/product described herein,

In one embodiment, a multiple-metal particle consists of a composition falling within the scope of a 2xxx aluminum alloy, as defined in the Teal Sheets, optionally comprising tolerable levels of oxygen (e.g., from about 0.01 to 0.20 wt. % O) therein due to normal additive manufacturing processes. A 2xxx aluminum alloy is an aluminum alloy comprising copper (Cu) as the predominate alloying ingredient, except for aluminum. The 2xxx aluminum alloy compositions include the 2xx alloy compositions of the Pink Sheets. Also, as used herein, the term “2xxx aluminum alloy” only refers to the composition and not any associated processing, i.e., as used herein a 2xxx aluminum alloy product does not need to be a wrought product to be considered a 2xxx aluminum alloy composition/product described herein,

In one embodiment, a multiple-metal particle consists of a composition falling within the scope of a 3xxx aluminum alloy, as defined in the Teal Sheets, optionally comprising tolerable levels of oxygen (e.g., from about 0.01 to 0.20 wt. % O) therein due to normal additive manufacturing processes. A 3xxx aluminum alloy is an aluminum alloy comprising manganese (Mn) as the predominate alloying ingredient, except for aluminum. Also, as used herein, the term “3xxx aluminum alloy” only refers to the composition and not any associated processing, i.e., as used herein a 3xxx aluminum alloy product does not need to be a wrought product to be considered a 3xxx aluminum alloy composition/product described herein,

In one embodiment, a multiple-metal particle consists of a composition falling within the scope of a 4xxx aluminum alloy, as defined in the Teal Sheets, optionally comprising tolerable levels of oxygen (e.g., from about 0.01 to 0.20 wt. % O) therein due to normal additive manufacturing processes. A 4xxx aluminum alloy is an aluminum alloy comprising silicon (Si) as the predominate alloying ingredient, except for aluminum. The 4xxx aluminum alloy compositions include the 3xx alloy compositions and the 4xx alloy compositions of the Pink Sheets. Also, as used herein, the term “4xxx aluminum alloy” only refers to the composition and not any associated processing, i.e., as used herein a 4xxx aluminum alloy product does not need to be a wrought product to be considered a 4xxx aluminum alloy composition/product described herein,

In one embodiment, a multiple-metal particle consists of a composition consisting with a 5xxx aluminum alloy, as defined in the Teal Sheets, optionally comprising tolerable levels of oxygen (e.g., from about 0.01 to 0.20 wt. % O) therein due to normal additive manufacturing processes. A 5xxx aluminum alloy is an aluminum alloy comprising magnesium (Mg) as the predominate alloying ingredient, except for aluminum. The 5xxx aluminum alloy compositions include the 5xx alloy compositions of the Pink Sheets. Also, as used herein, the term “5xxx aluminum alloy” only refers to the composition and not any associated processing, i.e., as used herein a 5xxx aluminum alloy product does not need to be a wrought product to be considered a 5xxx aluminum alloy composition/product described herein,

In one embodiment, a multiple-metal particle consists of a composition falling within the scope of a 6xxx aluminum alloy, as defined in the Teal Sheets, optionally comprising tolerable levels of oxygen (e.g., from about 0.01 to 0.20 wt. % O) therein due to normal additive manufacturing processes. A 6xxx aluminum alloy is an aluminum alloy comprising both silicon and magnesium, and in amounts sufficient to form the precipitate Mg₂Si. Also, as used herein, the term “6xxx aluminum alloy” only refers to the composition and not any associated processing, i.e., as used herein a 6xxx aluminum alloy product does not need to be a wrought product to be considered a 6xxx aluminum alloy composition/product described herein,

In one embodiment, a multiple-metal particle consists of a composition falling within the scope of a 7xxx aluminum alloy, as defined in the Teal Sheets, optionally comprising tolerable levels of oxygen (e.g., from about 0.01 to 0.20 wt. % O) therein due to normal additive manufacturing processes. A 7xxx aluminum alloy is an aluminum alloy comprising zinc (Zn) as the predominate alloying ingredient, except for aluminum. The 7xxx aluminum alloy compositions include the 7xx alloy compositions of the Pink Sheets. Also, as used herein, the term “7xxx aluminum alloy” only refers to the composition and not any associated processing, i.e., as used herein a 7xxx aluminum alloy product does not need to be a wrought product to be considered a 7xxx aluminum alloy composition/product described herein,

In one embodiment, a multiple-metal particle consists of a composition falling within the scope of a 8xxx aluminum alloy, as defined in the Teal Sheets, optionally comprising tolerable levels of oxygen (e.g., from about 0.01 to 0.20 wt. % O) therein due to normal additive manufacturing processes. A 8xxx aluminum alloy is any aluminum alloy that is not a 1xxx-7xxx aluminum alloy. Examples of 8xxx aluminum alloys include alloys having iron or lithium as the predominate alloying element, other than aluminum. The 8xxx aluminum alloy compositions include the 8xx alloy compositions and the 9xx alloy compositions of the Pink Sheets. As noted in ANSI H35.1 (2009), referenced by the Pink Sheets, the 9xx alloy compositions are aluminum alloys with “other elements” other than copper, silicon, magnesium, zinc, and tin, as the major alloying element. Also, as used herein, the term “8xxx aluminum alloy” only refers to the composition and not any associated processing, i.e., as used herein an 8xxx aluminum alloy product does not need to be a wrought product to be considered an 8xxx aluminum alloy composition/product described herein,

In one embodiment, at least some of the metal particles of the metal powder are metal-nonmetal (M-NM) particles. Metal-nonmetal (M-NM) particles include at least one metal with at least one non-metal. Examples of non-metal elements include oxygen, carbon, nitrogen and boron. Examples of M-NM particles include metal oxide particles (e.g., Al₂O₃), metal carbide particles (e.g., TiC), metal nitride particles (e.g., Si₃N₄), metal borides (e.g., TiB₂), and combinations thereof.

The metal particles and/or the non-metal particles of the metal powder may have tailored physical properties. For example, the particle size, the particle size distribution of the powder, and/or the shape of the particles may be pre-selected. In one embodiment, one or more physical properties of at least some of the particles are tailored in order to control at least one of the density (e.g., bulk density and/or tap density), the flowability of the metal powder, and/or the percent void volume of the metal powder bed (e.g., the percent porosity of the metal powder bed). For example, by adjusting the particle size distribution of the particles, voids in the powder bed may be restricted, thereby decreasing the percent void volume of the powder bed. In turn, aluminum alloy products having an actual density close to the theoretical density may be produced. In this regard, the metal powder may comprise a blend of powders having different size distributions. For example, the metal powder may comprise a blend of a first metal powder having a first particle size distribution and a second metal powder having a second particle size distribution, wherein the first and second particle size distributions are different. The metal powder may further comprise a third metal powder having a third particle size distribution, a fourth metal powder having a fourth particle size distribution, and so on. Thus, size distribution characteristics such as median particle size, average particle size, and standard deviation of particle size, among others, may be tailored via the blending of different metal powders having different particle size distributions. In one embodiment, a final aluminum alloy product realizes a density within 98% of the product's theoretical density. In another embodiment, a final aluminum alloy product realizes a density within 98.5% of the product's theoretical density. In yet another embodiment, a final aluminum alloy product realizes a density within 99.0% of the product's theoretical density. In another embodiment, a final aluminum alloy product realizes a density within 99.5% of the product's theoretical density. In yet another embodiment, a final aluminum alloy product realizes a density within 99.7%, or higher, of the product's theoretical density.

The metal powder may comprise any combination of one-metal particles, multiple-metal particles, M-NM particles and/or non-metal particles to produce the tailored aluminum alloy product, and, optionally, with any pre-selected physical property. For example, the metal powder may comprise a blend of a first type of metal particle with a second type of particle (metal or non-metal), wherein the first type of metal particle is a different type than the second type (compositionally different, physically different or both). The metal powder may further comprise a third type of particle (metal or non-metal), a fourth type of particle (metal or non-metal), and so on. As described in further detail below, the metal powder may be the same metal powder through the additive manufacturing of the aluminum alloy product, or the metal powder may be varied during the additive manufacturing process.

As noted above, additive manufacturing may be used to create, layer-by-layer, an aluminum alloy product. In one embodiment, a metal powder bed is used to create an aluminum alloy product (e.g., a tailored aluminum alloy product). As used herein a “metal powder bed” means a bed comprising a metal powder. During additive manufacturing, particles of different compositions may melt (e.g., rapidly melt) and then solidify (e.g., in the absence of homogenous mixing). Thus, aluminum alloy products having a homogenous or non-homogeneous microstructure may be produced, which aluminum alloy products cannot be achieved via conventional shape casting or wrought product production methods.

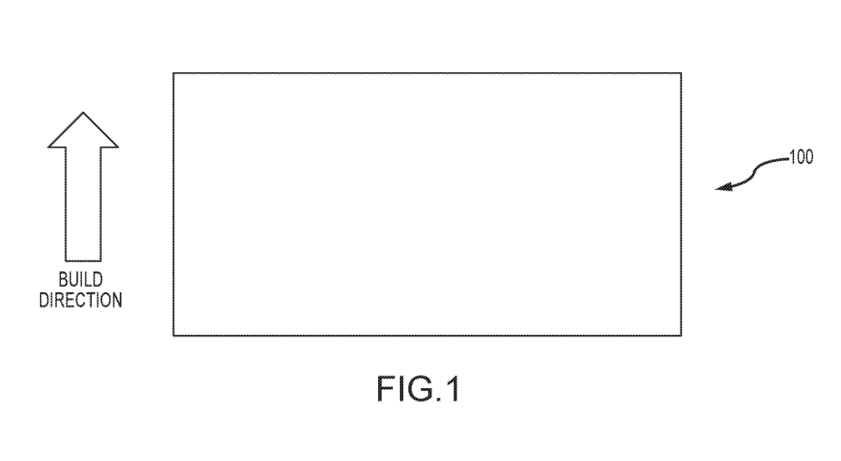

In one embodiment, the same general powder is used throughout the additive manufacturing process to produce an aluminum alloy product. For instance, and referring now to FIG. 1, the final tailored aluminum alloy product (100) may comprise a single region produced by using generally the same metal powder during the additive manufacturing process. In one embodiment, the metal powder consists of one-metal particles. In one embodiment, the metal powder consists of a mixture of one-metal particles and multiple-metal particles. In one embodiment, the metal powder consists of one-metal particles and M-NM particles. In one embodiment, the metal powder consists of one-metal particles, multiple-metal particles and M-NM particles. In one embodiment, the metal powder consists of multiple-metal particles. In one embodiment, the metal powder consists of multiple-metal particles and M-NM particles. In one embodiment, the metal powder consists of M-NM particles. In any of these embodiments, non-metal particles may be optionally used in the metal powder. In any of these embodiments, multiple different types of the one-metal particles, the multiple-metal particles, the M-NM particles, and/or the non-metal particles may be used to produce the metal powder. For instance, a metal powder consisting of one-metal particles may include multiple different types of one-metal particles. As another example, a metal powder consisting of multiple-metal particles may include multiple different types of multiple-metal particles. As another example, a metal powder consisting of one-metal and multiple metal particles may include multiple different types of one-metal and/or multiple metal particles. Similar principles apply to M-NM and non-metal particles.

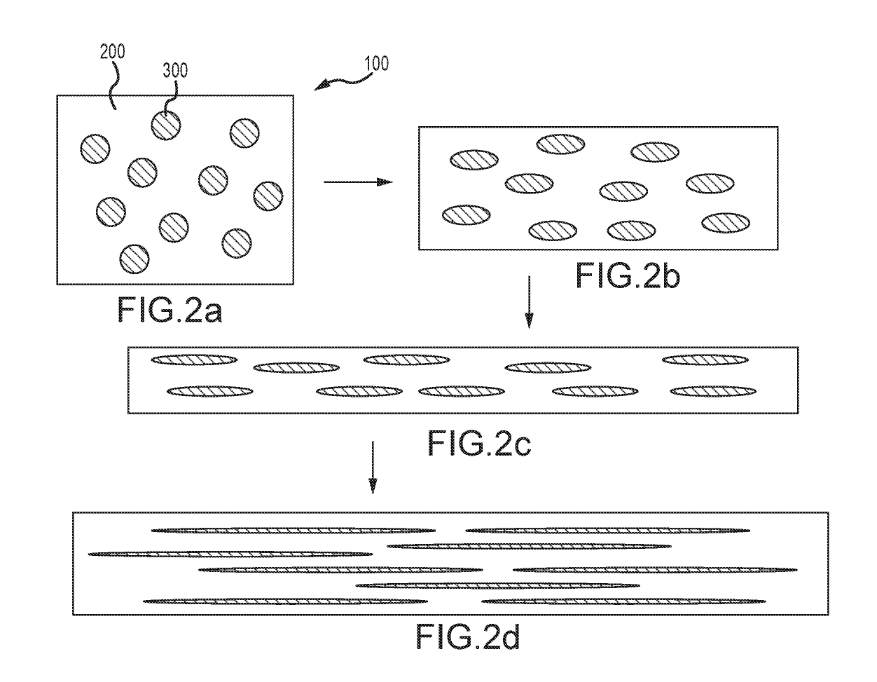

As one specific example, and with reference now to FIGS. 2a-2d, the single metal powder may include a blend of (1) at least one of (a) M-NM particles and (b) non-metal particles (e.g., BN particles) and (2) at least one of (a) one-metal particles or (b) multiple-metal particles. The single powder blend may be used to produce an aluminum alloy body having a large volume of a first region (200) and smaller volume of a second region (300). For instance, the first region (200) may comprise an aluminum alloy region (e.g., due to the one-metal particles and/or multiple metal particles), and the second region (300) may comprise an M-NM region (e.g., due to the M-NM particles and/or the non-metal particles). After or during production, an additively manufactured product comprising the first region (200) and the second region (300) may be deformed (e.g., by one or more of rolling, extruding, forging, stretching, compressing), as illustrated in FIGS. 2b-2d. The final deformed product may realize, for instance, higher strength due to the interface between the first region (200) and the M-NM second region (300), which may restrict planar slip.

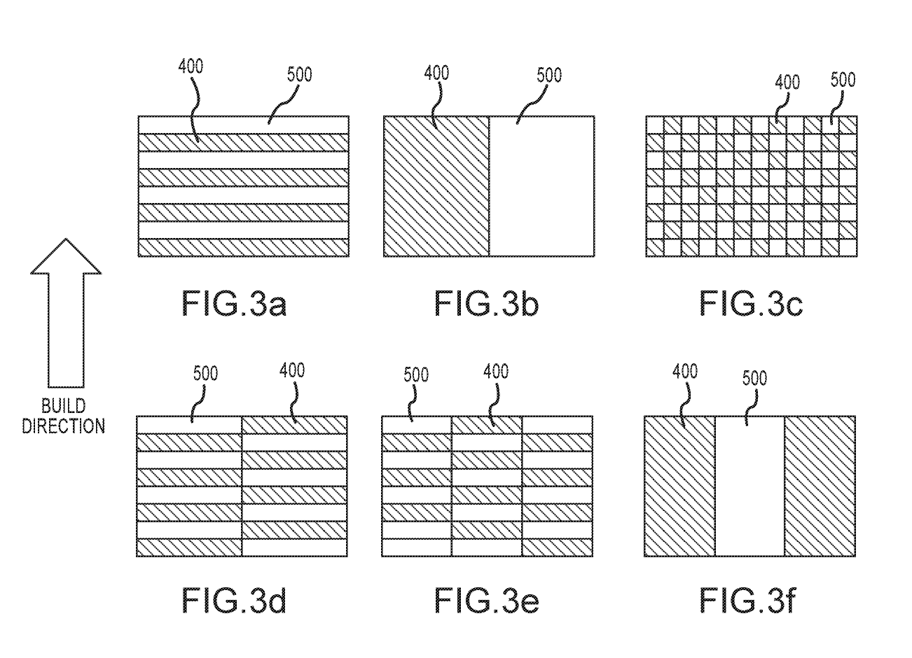

The final tailored aluminum alloy product may alternatively comprise at least two separately produced distinct regions. In one embodiment, different metal powder bed types may be used to produce an aluminum alloy product. For instance, a first metal powder bed may comprise a first metal powder and a second metal powder bed may comprise a second metal powder, different than the first metal powder. The first metal powder bed may be used to produce a first layer or portion of an aluminum alloy product, and the second metal powder bed may be used to produce a second layer or portion of the aluminum alloy product. For instance, and with reference now to FIGS. 3a-3f, a first region (400) and a second region (500), may be present. To produce the first region (400), a first portion (e.g., a layer) of a metal powder bed may comprise a first metal powder. To produce the second region (500), a second portion (e.g., a layer) of metal powder may comprise a second metal powder, different than the first layer (compositionally and/or physically different). Third distinct regions, fourth distinct regions, and so on can be produced using additional metal powders and layers. Thus, the overall composition and/or physical properties of the metal powder during the additive manufacturing process may be pre-selected, resulting in tailored aluminum alloy products having tailored compositions and/or microstructures.

In one aspect, the first metal powder consists of one-metal particles. The first metal powder may be used in a first metal powder bed layer to produce a first region (400) of a tailored aluminum alloy body. Subsequently, a second metal powder may be used as a second metal powder bed layer to produce a second region (500) of a tailored aluminum alloy body. In one embodiment, the second metal powder consists of another type of one-metal particles. In another embodiment, the second metal powder consists of one-metal particles and multiple-metal particles. In yet another embodiment, the second metal powder consists of one-metal particles and M-NM particles. In another embodiment, the second metal powder consists of one-metal particles, multiple-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder consists of multiple-metal particles. The first metal powder may be used in a first metal powder bed layer to produce a first region (400) of a tailored aluminum alloy body. Subsequently, a second metal powder may be used as a second metal powder bed layer to produce a second region (500) of a tailored aluminum alloy body. In one embodiment, the second metal powder consists of another type of multiple-metal particles. In another embodiment, the second metal powder consists of one-metal particles. In yet another embodiment, the second metal powder consists of a mixture of one-metal particles and multiple-metal particles. In another embodiment, the second metal powder consists of a mixture of one-metal particles and M-NM particles. In yet another embodiment, the second metal powder consists of one-metal particles, multiple-metal particles and M-NM particles. In another embodiment, the second metal powder consists of a mixture of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder consists of M-NM particles. The first metal powder may be used in a first metal powder bed layer to produce a first region (400) of a tailored aluminum alloy body. Subsequently, a second metal powder may be used as a second metal powder bed layer to produce a second region (500) of a tailored aluminum alloy body. In one embodiment, the second metal powder consists of another type of M-NM particles. In another embodiment, the second metal powder consists of one-metal particles. In yet another embodiment, the second metal powder consists of one-metal particles and multiple-metal particles. In another embodiment, the second metal powder consists of one-metal particles and M-NM particles. In yet another embodiment, the second metal powder consists of one-metal particles, multiple-metal particles and M-NM particles. In another embodiment, the second metal powder consists of multiple-metal particles. In another embodiment, the second metal powder consists of multiple-metal particles and M-NM particles. In any of these embodiments, non-metal particles may be optionally used in the second metal powder to produce the second region.

In another aspect, the first metal powder consists of a mixture of one-metal particles and multiple-metal particles. The first metal powder may be used in a first metal powder bed layer to produce a first region (400) of a tailored aluminum alloy body. Subsequently, a second metal powder may be used as a second metal powder bed layer to produce a second region (500) of a tailored aluminum alloy body. In one embodiment, the second metal powder consists of another mixture of one-metal particles and multiple metal particles. In another embodiment, the second metal powder consists of one-metal particles. In yet another embodiment, the second metal powder consists of one-metal particles and M-NM particles. In another embodiment, the second metal powder consists of one-metal particles, multiple-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder consists of a mixture of one-metal particles and M-NM particles. The first metal powder may be used in a first metal powder bed layer to produce a first region (400) of a tailored aluminum alloy body. Subsequently, a second metal powder may be used as a second metal powder bed layer to produce a second region (500) of a tailored aluminum alloy body. In one embodiment, the second metal powder consists of another mixture of one-metal particles and M-NM particles. In another embodiment, the second metal powder consists of one-metal particles. In yet another embodiment, the second metal powder consists of one-metal particles and multiple-metal particles. In another embodiment, the second metal powder consists of one-metal particles, multiple-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder consists of a mixture of one-metal particles, multiple-metal particles and M-NM particles. The first metal powder may be used in a first metal powder bed layer to produce a first region (400) of a tailored aluminum alloy body. Subsequently, a second metal powder may be used as a second metal powder bed layer to produce a second region (500) of a tailored aluminum alloy body. In one embodiment, the second metal powder consists of another mixture of one-metal particles, multiple-metal particles and M-NM particles. In another embodiment, the second metal powder consists of one-metal particles. In yet another embodiment, the second metal powder consists of one-metal particles and multiple-metal particles. In another embodiment, the second metal powder consists of one-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder consists of a mixture of multiple-metal particles and M-NM particles. The first metal powder may be used in a first metal powder bed layer to produce a first region (400) of a tailored aluminum alloy body. Subsequently, a second metal powder may be used as a second metal powder bed layer to produce a second region (500) of a tailored aluminum alloy body. In one embodiment, the second metal powder consists of another mixture of multiple-metal particles and M-NM particles. In another embodiment, the second metal powder consists of one-metal particles. In yet another embodiment, the second metal powder consists of one-metal particles and multiple-metal particles. In another embodiment, the second metal powder consists of one-metal particles and M-NM particles. In yet another embodiment, the second metal powder consists of multiple-metal particles. In another embodiment, the second metal powder consists of one-metal particles, multiple-metal particles and M-NM particles. In yet another embodiment, the second metal powder consists of M-NM particles. In any of these embodiments, non-metal particles may be optionally used in the second metal powder to produce the second region.

The powders used to in the additive manufacturing processes described herein may be produced by atomizing a material (e.g., an ingot) of the appropriate material into powders of the appropriate dimensions relative to the additive manufacturing process to be used.

After or during production, an additively manufactured product may be deformed (e.g., by one or more of rolling, extruding, forging, stretching, compressing). The final deformed product may realize, for instance, improved properties due to the tailored regions of the aluminum alloy product.

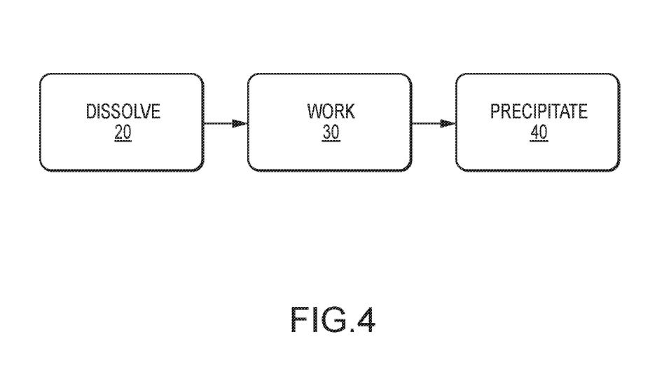

Referring now to FIG. 4, the additively manufactured product may be subject to any appropriate dissolving (20), working (30) and/or precipitation hardening steps (40). If employed, the dissolving (20) and/or the working (30) steps may be conducted on an intermediate form of the additively manufactured body and/or may be conducted on a final form of the additively manufactured body. If employed, the precipitation hardening step (40) is generally conducted relative to the final form of the additively manufactured body.

With continued reference to FIG. 4, the method may include one or more dissolving steps (20), where an intermediate product form and/or the final product form are heated above a solvus temperature of the product but below the solidus temperature of the material, thereby dissolving at least some of the undissolved particles. The dissolving step (20) may include soaking the material for a time sufficient to dissolve the applicable particles. In one embodiment, a dissolving step (20) may be considered a homogenization step. After the soak, the material may be cooled to ambient temperature for subsequent working. Alternatively, after the soak, the material may be immediately hot worked via the working step (30).

The working step (30) generally involves hot working and/or cold working an intermediate product form. The hot working and/or cold working may include rolling, extrusion or forging of the material, for instance. The working (30) may occur before and/or after any dissolving step (20). For instance, after the conclusion of a dissolving step (20), the material may be allowed to cool to ambient temperature, and then reheated to an appropriate temperature for hot working. Alternatively, the material may be cold worked at around ambient temperatures. In some embodiments, the material may be hot worked, cooled to ambient, and then cold worked. In yet other embodiments, the hot working may commence after a soak of a dissolving step (20) so that reheating of the product is not required for hot working.

The working step (30) may result in precipitation of second phase particles. In this regard, any number of post-working dissolving steps (20) can be utilized, as appropriate, to dissolve at least some of the undissolved second phase particles that may have formed due to the working step (30).

After any appropriate dissolving (20) and working (30) steps, the final product form may be precipitation hardened (40). The precipitation hardening (40) may include heating the final product form above a solvus temperature for a time sufficient to dissolve at least some particles precipitated due to the working, and then rapidly cooling the final product form. The precipitation hardening (40) may further include subjecting the product to a target temperature for a time sufficient to form precipitates (e.g., strengthening precipitates), and then cooling the product to ambient temperature, thereby realizing a final aged product having desired precipitates therein. As may be appreciated, at least some working (30) of the product may be completed after a precipitating (40) step. In one embodiment, a final aged product contains ≧0.5 vol. % of the desired precipitates (e.g., strengthening precipitates) and ≦0.5 vol. % of coarse second phase particles.

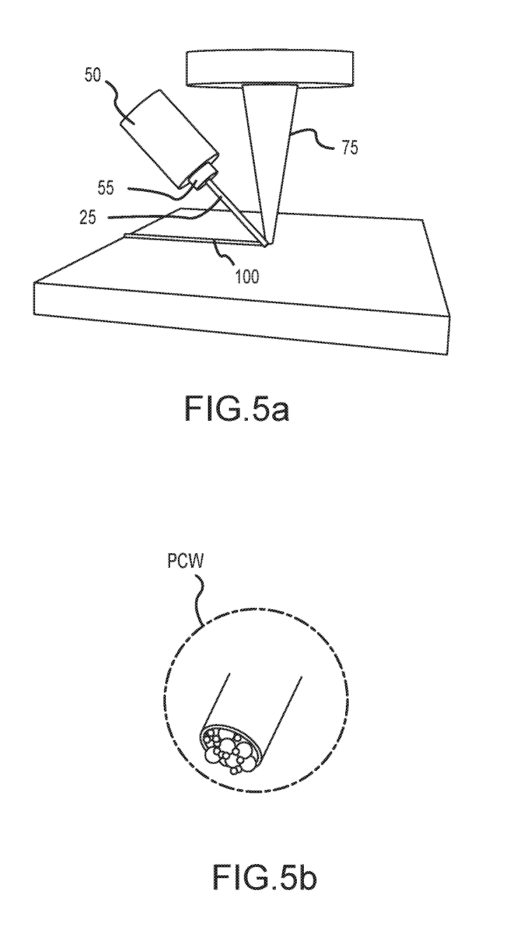

In one approach, electron beam (EB) or plasma arc techniques are utilized to produce at least a portion of the additively manufactured aluminum alloy body. Electron beam techniques may facilitate production of larger parts than readily produced via laser additive manufacturing techniques. For instance, and with reference now to FIG. 5a, in one embodiment, a method comprises feeding a small diameter wire (25) (e.g., ≦2.54 mm in diameter) to the wire feeder portion (55) of an electron beam gun (50). The wire (25) may be of the compositions, described above, provided it is a drawable composition (e.g., when produced per the process conditions of U.S. Pat. No. 5,286,577), or the wire is producible via powder conform extrusion, for instance (e.g., as per U.S. Pat. No. 5,284,428). The electron beam (75) heats the wire or tube, as the case may be, above the liquidus point of the body to be formed, followed by rapid solidification of the molten pool to form the deposited material (100).

In one embodiment, and referring now to FIG. 5b, the wire (25) is a powder cored wire (PCW), where a tube portion of the wire contains a volume of the particles therein, such as any of the particles described above (one-metal particles, multiple metal particles, metal-nonmetal particles, non-metal particles, and combinations thereof), while the tube itself may comprise aluminum or an aluminum alloy (e.g., a suitable 1xxx-8xxx aluminum alloy). The composition of the volume of particles within the tube may be adapted to account for the amount of aluminum in the tube so as to realize the appropriate end composition.

In one embodiment, the tube is a high purity aluminum or a 1xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 1xxx aluminum alloy and the particles comprise one-metal particles. In one embodiment, the tube is a high purity aluminum or a 1xxx aluminum alloy and the particles comprise multiple metal particles. In one embodiment, the tube is a high purity aluminum or a 1xxx aluminum alloy and the particles comprise metal-nonmetal particles. In one embodiment, the tube is a high purity aluminum or a 1xxx aluminum alloy and the particles comprise non-metal particles. In one embodiment, the tube is a high purity aluminum or a 1xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 1xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 1xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

In one embodiment, the tube is a high purity aluminum or a 2xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 2xxx aluminum alloy and the particles comprise one-metal particles. In one embodiment, the tube is a high purity aluminum or a 2xxx aluminum alloy and the particles comprise multiple metal particles. In one embodiment, the tube is a high purity aluminum or a 2xxx aluminum alloy and the particles comprise metal-nonmetal particles. In one embodiment, the tube is a high purity aluminum or a 2xxx aluminum alloy and the particles comprise non-metal particles. In one embodiment, the tube is a high purity aluminum or a 2xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 2xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 2xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

In one embodiment, the tube is a high purity aluminum or a 3xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 3xxx aluminum alloy and the particles comprise one-metal particles. In one embodiment, the tube is a high purity aluminum or a 3xxx aluminum alloy and the particles comprise multiple metal particles. In one embodiment, the tube is a high purity aluminum or a 3xxx aluminum alloy and the particles comprise metal-nonmetal particles. In one embodiment, the tube is a high purity aluminum or a 3xxx aluminum alloy and the particles comprise non-metal particles. In one embodiment, the tube is a high purity aluminum or a 3xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 3xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 3xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

In one embodiment, the tube is a high purity aluminum or a 4xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 4xxx aluminum alloy and the particles comprise one-metal particles. In one embodiment, the tube is a high purity aluminum or a 4xxx aluminum alloy and the particles comprise multiple metal particles. In one embodiment, the tube is a high purity aluminum or a 4xxx aluminum alloy and the particles comprise metal-nonmetal particles. In one embodiment, the tube is a high purity aluminum or a 4xxx aluminum alloy and the particles comprise non-metal particles. In one embodiment, the tube is a high purity aluminum or a 4xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 4xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 4xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

In one embodiment, the tube is a high purity aluminum or a 5xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 5xxx aluminum alloy and the particles comprise one-metal particles. In one embodiment, the tube is a high purity aluminum or a 5xxx aluminum alloy and the particles comprise multiple metal particles. In one embodiment, the tube is a high purity aluminum or a 5xxx aluminum alloy and the particles comprise metal-nonmetal particles. In one embodiment, the tube is a high purity aluminum or a 5xxx aluminum alloy and the particles comprise non-metal particles. In one embodiment, the tube is a high purity aluminum or a 5xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 5xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 5xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

In one embodiment, the tube is a high purity aluminum or a 6xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 6xxx aluminum alloy and the particles comprise one-metal particles. In one embodiment, the tube is a high purity aluminum or a 6xxx aluminum alloy and the particles comprise multiple metal particles. In one embodiment, the tube is a high purity aluminum or a 6xxx aluminum alloy and the particles comprise metal-nonmetal particles. In one embodiment, the tube is a high purity aluminum or a 6xxx aluminum alloy and the particles comprise non-metal particles. In one embodiment, the tube is a high purity aluminum or a 6xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 6xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 6xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

In one embodiment, the tube is a high purity aluminum or a 7xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 7xxx aluminum alloy and the particles comprise one-metal particles. In one embodiment, the tube is a high purity aluminum or a 7xxx aluminum alloy and the particles comprise multiple metal particles. In one embodiment, the tube is a high purity aluminum or a 7xxx aluminum alloy and the particles comprise metal-nonmetal particles. In one embodiment, the tube is a high purity aluminum or a 7xxx aluminum alloy and the particles comprise non-metal particles. In one embodiment, the tube is a high purity aluminum or a 7xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 7xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 7xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

In one embodiment, the tube is a high purity aluminum or a 8xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 8xxx aluminum alloy and the particles comprise one-metal particles. In one embodiment, the tube is a high purity aluminum or a 8xxx aluminum alloy and the particles comprise multiple metal particles. In one embodiment, the tube is a high purity aluminum or a 8xxx aluminum alloy and the particles comprise metal-nonmetal particles. In one embodiment, the tube is a high purity aluminum or a 8xxx aluminum alloy and the particles comprise non-metal particles. In one embodiment, the tube is a high purity aluminum or a 8xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 8xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 8xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

While various embodiments of the new technology described herein have been described in detail, it is apparent that modifications and adaptations of those embodiments will occur to those skilled in the art. However, it is to be expressly understood that such modifications and adaptations are within the spirit and scope of the presently disclosed technology.

What is claimed is:

1. A method for producing an aluminum alloy product, the method comprising:
(a) dispersing a metal powder in a bed, wherein the metal powder comprises first metal particles and second metal particles, and wherein the first metal particles comprise aluminum and wherein the second metal particles comprise a metal other than aluminum, wherein the second metal particles comprise a different composition than the first metal particles, wherein the first metal particles have a first tailored particle size distribution, wherein the second metal particles have a second tailored particle size distribution, wherein the first tailored particle size distribution is different than the second tailored particle size distribution;
(b) selectively heating a portion of the metal powder to a temperature above the liquidus temperature of the aluminum alloy product;
(c) forming a molten pool;
(d) cooling the molten pool at a cooling rate of at least 1000° C. per second; and
(e) repeating steps (a)-(d) until the aluminum alloy product is completed.

2. The method for claim 1, wherein the first metal particles are first one-metal particles, and wherein the first one-metal particles consist essentially of aluminum.

3. The method for claim 2, wherein the second metal particles are second one-metal particles, wherein the second one-metal particles consistent essentially of a metal other than aluminum.

4. The method of claim 2, wherein the second one-metal particles consist essentially of a metal selected from the group consisting of, copper, manganese, silicon, magnesium, zinc, iron, titanium, zirconium, chromium, nickel, tin, silver, vanadium, and a rare earth element.

5. The method of claim 1, wherein the first metal particles are first multiple-metal particles, wherein the first multiple-metal particles comprise aluminum and at least one other metal.

6. The method of claim 5, wherein the first multiple-metal particles consist of an aluminum alloy.

7. The method of claim 5, wherein the first multiple-metal particles consist of an aluminum alloy, wherein the aluminum alloy is selected from the group consisting of the 2xxx, 3xxx, 4xxx, 5xxx, 6xxx, 7xxx, and 8xxx aluminum alloys.

8. The method of claim 2, wherein the second metal particles are metal-nonmetal particles.

9. The method of claim 8, wherein the metal-nonmetal particles comprise at least one of oxygen, carbon, nitrogen and boron.

10. The method of claim 9, wherein the metal-nonmetal particles are selected from the group consisting of metal oxide particles, metal carbide particles, metal nitride particles, and combinations thereof.

11. The method of claim 9, wherein the metal-nonmetal particles are one of Al₂O₃, TiC, Si₃N₄ and TiB₂.

12. The method of claim 2, wherein the second metal particles are non-metal particles.

13. A method of making an aluminum alloy product, the method comprising:
(a) first producing a first region of an aluminum alloy body via a first metal powder, wherein the first metal powder comprises aluminum;
(i) wherein the first producing step comprises using additive manufacturing to make the first region of the aluminum alloy product, wherein the first producing step comprises heating the first metal powder using a single radiation source;
(b) second producing a second region of an aluminum alloy body via a second metal powder, wherein the first metal powder is different than the second metal powder;
(i) wherein the second producing step comprises using additive manufacturing to make the second region of the aluminum alloy product, wherein the second producing step comprises heating the second metal powder using the single radiation source;
(ii) wherein the second region is adjacent the first region.

14. The method of claim 13, wherein the first metal powder comprise metal particles, wherein the metal particles comprise aluminum, and wherein the metal particles are selected from the group consisting of first one-metal particles, first multiple-metal particles, first metal-nonmetal particles, and combinations thereof.

15. The method of claim 14, wherein the second metal powder comprises second one-metal particles, wherein the second one-metal particles consistent essentially of a metal other than aluminum.

16. The method of claim 15, wherein the second metal powder further comprises multiple-metal particles.

17. The method of claim 15, wherein the second metal powder further comprises metal-nonmetal particles.

18. The method of claim 13, wherein the second metal powder comprises non-metal particles.

19. A wire for use in electron beam or plasma arc additive manufacturing, the wire comprising:
an outer tube portion; and
a volume of particles contained within the outer tube portion;
wherein the outer tube portion is a 1xxx aluminum alloy, and
wherein the volume of particles contained within the outer tube portion is selected from the group consisting of one-metal particles, multiple metal particles, metal-nonmetal particles, non-metal particles, and combinations thereof.

20. A method comprising:
using the wire of claim 19 to produce an aluminum alloy product, wherein the using comprises using electron beam or plasma arc additive manufacturing.
